(19) United States
(12) Patent Application Publication
(10) Pub. No.: US 2026/0036317 A1
(43) Pub. Date: Feb. 5, 2026

(54) INTEGRATED SMART RING AND ENVIRONMENT SENSING SYSTEM FOR ENHANCED HVAC EFFICIENCY AND LIFESTYLE IMPROVEMENT

(71) Applicant: ULTRAHUMAN HEALTHCARE PVT LTD, Bangalore South (IN)

(72) Inventors: Jaskaran SINGH, Patiala, Punjab (IN); Mohit KUMAR, Bangalore (IN); Vatsal SINGHAL, Bangalore (IN); Adhit SHET, Bangalore (IN); Bhuvan SRINIVASAN, Bangalore (IN)

(73) Assignee: ULTRAHUMAN HEALTHCARE PVT LTD, Bangalore South (IN)

(21) Appl. No.: 19/351,478

(22) Filed: Oct. 7, 2025

Related U.S. Application Data
(63) Continuation of application No. PCT/IN2025/050366, filed on Mar. 13, 2025.

(30) Foreign Application Priority Data
Mar. 16, 2024 (IN) 202441019479

(51) Int. Cl. F24F 11/50; F24F 11/46; F24F 11/64; F24F 110/00; F24F 120/10; F24F 120/20

(52) U.S. Cl. CPC F24F 11/50; F24F 11/46; F24F 11/64; F24F 2110/00; F24F 2120/10; F24F 2120/20

(57) ABSTRACT

The present disclosure provides an integrated system designed for the dynamic optimization of HVAC efficiency and lifestyle improvement based on real-time biomarker and environmental data. Incorporating a smart ring with biomarker sensors and an always-plugged-in environment sensing device, the system provides intelligent suggestions for HVAC settings and identifies potential causes of discomfort, enhancing comfort, health, and overall well-being.

### RELATED APPLICATIONS

This application is a continuation of International Application No. PCT/IN2025/050366 filed Mar. 13, 2025, which claims priority to India application No. 202441019479 filed Mar. 16, 2024, each of which is hereby incorporated herein by reference in its entirety.

### FIELD OF INVENTION

The present disclosure relates to controlling a Heating, Ventilation, and Air Conditioning (HVAC) system. In particular, the present disclosure relates to the controlling of the HVAC system based on a user's biometric parameters.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In general, a Heating, Ventilation, and Air-conditioning (HVAC) system is deployed in a building facility or indoor area for providing comfort to the users present in an indoor facility. Generally, the HVAC system operates based on direct user input based on set temperature/moisture/airflow speed. However, the HVAC system does not regulate itself due to external factors such as a change in occupancy, outside temperature, and environmental conditions.

For example, the HVAC systems often operate on a fixed schedule or set points, which may not align with actual occupancy or conditions. For example, a building may be heated or cooled during the times it is unoccupied, leading to substantial energy waste. Further, these systems typically lack the ability to adapt to varying environmental and physiological conditions of the users. For example, the HVAC system does not take into account factors such as:
changes in outdoor temperature/humidity,
varied occupancy levels (e.g., more people in the afternoon),
individual preferences of occupants,
sudden health issues of the users.

For example, when a user is high in body temperature or has other conditions that require regulating indoor facility conditions, the current HVAC system proves inefficient in handling such a situation.

Thus, the HVAC systems are inefficient and uncomfortable for the user. Further, the HVAC systems contribute to unnecessary energy consumption.

There is a need for a more intelligent system that can dynamically adjust the settings of the HVAC systems based on real-time physiological and environmental data to enhance both comfort and lifestyle.

### OBJECT OF THE INVENTION

A general objective of the invention is to regulate ambient conditions of an indoor facility involving an HVAC system, using biomarker sensors and an environmental sensor module and integrating both for dynamic HVAC optimization and comfort improvement for the user.

Another objective of the invention is to provide a smart wearable device like a smart ring having one or more sensors for biomarkers, for continuous use by the user and integrating the biomarker sensors with the environment sensor devices.

Another objective of the invention is to provide the environmental sensor module that is configured to sense the environmental conditions, receive biomarker data from the smart ring by way of integration, and accordingly regulate the HVAC system for optimization.

Yet another objective of the invention is to provide an integrated system that can use at least one of the biomarker sensors or the environment sensors for the optimization of the HVAC system.

### SUMMARY OF THE INVENTION

The summary is provided to introduce aspects related to integrated biomarker sensors and environment sensors for HVAC optimization, and the aspects are further described below in the description. This summary is not intended to identify essential features of the claimed subject matter nor is it intended for use in determining or limiting the scope of the claimed subject matter.

The present disclosure seeks to address the challenges of effective HVAC optimization by providing a smart ring equipped with biomarker sensors and an environment sensing device. These devices can individually provide suggestions for HVAC settings based on their respective data and offer even more refined suggestions when used in tandem, continuously monitoring the user's physiological state and the indoor environment for dynamic HVAC optimization and lifestyle improvement.

According to an embodiment, a system for controlling an HVAC system based on user's biometric parameters is disclosed. In an embodiment, the system includes a wearable device worn by a user. The wearable device includes at least one biometric sensor configured to measure biometric parameters of the user. Further, the system includes an environmental sensor module configured to detect ambient conditions in a zone of user's presence and send controlling signal to a HVAC system. The system further includes a smart device coupled to the wearable device and the environmental sensor module. In an embodiment, the smart device comprises an executable application configured to receive the at least one biometric parameters of the user and identify a deviation based on a threshold. In an embodiment, the environmental sensor module further comprises a controller unit. According to an embodiment, the controller unit is configured to receive at least one biometric parameter associated with the user from the smart device and an indication of deviation based on the threshold. Further, the controller unit is configured to determine at least one ambient condition of the zone of user's presence and transmit one or more control signals for controlling one or more operating conditions of the HVAC system, based on the deviation of the at least one biometric parameter associated with the user, to achieve a desired ambient condition for the user.

According to a further embodiment, the method for controlling an HVAC system based on user's biometric parameters is disclosed. The method comprises detecting, by one or more biometric sensors of a wearable device, at least one biometric parameter of the user. The method further comprises sending the at least one detected biometric parameter of the user to a smart device, wherein the smart device includes an executable application. The method further comprises identifying, by the smart device, a deviation of the at least one biometric parameters based on a threshold. Further, the method comprises receiving, by an environmental sensor module, the at least one biometric parameters associated with the user from the smart device and an indication of the deviation of the at least one biometric parameters. Further, the method further comprises determine, by the environmental sensor module, at least one ambient condition of a zone of user's presence. Further, the method comprises transmit, by the environmental sensor module, one or more control signals to HVAC system for controlling one or more operating conditions based on deviation of the at least one biometric parameters of the user, to achieve a desired ambient condition.

Other aspects and advantages of the invention will become apparent from the following description, taken in conjunction with the accompanying drawings, illustrating by way of example the principles of the invention.

### BRIEF DESCRIPTION OF THE DRAWINGS

The accompanying drawings constitute a part of the description and are used to provide further understanding of the present invention. The drawings illustrate exemplary embodiments of the present disclosure and, together with the description, serve to explain the principles of the present disclosure.

FIG. 1 illustrates a system for optimizing the HVAC system, according to an embodiment of the present disclosure.

FIG. 2 illustrates a method 200 flow for controlling an HVAC system based on user's biometric parameters, according to an embodiment of the present disclosure.

FIG. 3 illustrates a general block diagram of the system 100, according to an embodiment of the present disclosure.

### DESCRIPTION OF THE INVENTION

The description set forth below in connection with the appended drawings is intended as a description of various embodiments of the present invention and is not intended to represent the only embodiments in which the present invention may be practiced.

Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present disclosure may be practiced without these specific details.

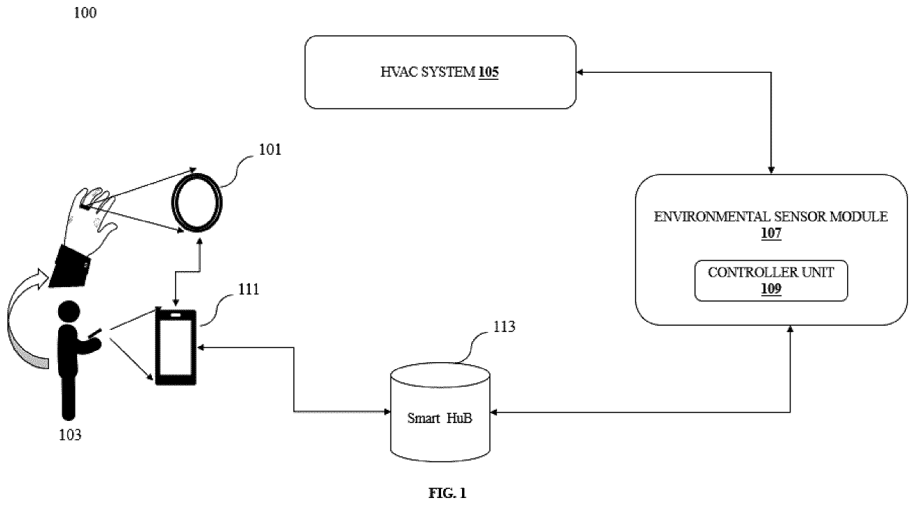

FIG. 1 illustrates a system for optimizing the HVAC system, according to an embodiment of the present disclosure. In an embodiment, the system 100 includes a wearable device 101 that can be worn by a user 103. The user 103 may be inside the indoor facility of a HVAC system 105. As an example, the HVAC system 105 includes the following but is not limited to:
Split Systems: Traditional system with separate indoor and outdoor units for heating and cooling; common in homes.
Central Air Conditioning: Centralized system that cools and distributes air using ductwork; common for medium-to-large buildings.
Humidifiers/Dehumidifiers: Regulate indoor humidity for comfort and air quality; used in areas with extreme dryness or humidity.

As an example, the wearable device 101 may be a smart ring that can be worn by the user 103. According to an embodiment, the wearable device 101 includes at least one biometric sensor configured to measure biometric parameters of the user 103. In an embodiment, the biometric sensor comprises at least one of a heart rate sensor, a skin temperature sensor, a blood oxygen sensor, a respiratory rate sensor, and a motion sensor.

According to an embodiment, the wearable device 101 continuously monitors the biometric parameters of the user 103. As an example, the biometric parameters include a body temperature, a heart rate, a heart rate variability (HRV), a movement, an acceleration, an oxygen level, a blood pressure, a palpitation rate, and a step count of the user 103.

For example, the wearable device monitors a user's body temperature throughout the day and collects data that can help track daily rhythms and patterns (e.g., higher temperatures due to exercise or illness). Further, continuous tracking of heart rate to monitor resting, active, maximum heart rates, exercise intensity, and recovery times. Further, measuring HRV for insights into stress or anxiety. For example, the HRV readings are collected to identify if the user is stressed or relaxed. The motion data allows the wearable device 101 to track whether the user is sitting, walking, or running. This can help in understanding the activity pattern of the user. Further, the oxygen level helps in monitoring the blood oxygen saturation level. The oxygen level helps to detect potential issues with oxygenation during sleep (e.g., sleep apnea) or high-altitude activities.

According to a further embodiment, the system 100 further includes an environmental sensor module 107 configured to detect ambient conditions in a zone of the user's 103 presence and send a controlling signal to the HVAC system 105. According to an embodiment, the environmental sensor module 107 is equipped with sensors to detect ambient conditions like a temperature, a humidity, an air quality, light levels, a noise level, a pressure level of the ambiance surrounding the user 103. Further, the environmental sensor module 107 detects the occupancy level of the users 103. In an embodiment, the environmental sensor module 107 further includes a controller unit 109 configured to send control signals to the HVAC system 105.

In an embodiment, the controller unit 109 is configured to receive at least one biometric parameters associated with the user. Further, the controller unit 109 is configured to determine at least one ambient condition of the zone of user's presence and transmit one or more control signals for controlling one or more operating conditions of the HVAC system 105.

According to a further embodiment, the wearable device 101 and the environmental sensor module 107 are further coupled with a smart device 111. As an example, the smart device 111 may be a smartphone or a tablet. According to an embodiment, the smart device 111 is further implemented with a software application (APP) that receives the at least one biometric parameters of the user. In an embodiment, the software APP receives the biometric parameters of the user 103 and sends the biometric parameters to the controller unit 109. According to a further embodiment, the software application (APP) of the wearable device 101 identifies a deviation in at least one biometric parameter of the user 103 and provide the indication of the deviation to the controller unit 109 for taking further actions.

According to an embodiment, the wearable device 101 is further coupled with a smart hub 113. In an embodiment, the smart hub 113 is further coupled to the HVAC system 105 for controlling and optimizing the system for regulating the indoor ambient conditions. In an embodiment, the wearable device 101 and the environmental sensor module 107 are coupled to the smart device 111 using one of a Bluetooth, a private network, or any wireless communication technology. In a further embodiment, the environmental sensor module 107 is configured to be coupled to the smart hub 113 using any standard wireless communication and protocols.

In an embodiment, the environmental sensor module 107 controls one or more operating conditions of the HVAC system 105 via the smart hub 113. According to some embodiments, the software application provides real-time feedback and suggestions for HVAC settings, which can be implemented through the smart hub 113. In an embodiment, the regulation of ambient conditions can be performed manually based on the recommendations provided by the software APP of the wearable device 101.

According to some embodiment, the smart hub 113 is connected to a plurality of devices. As an example, the plurality of devices may include air purifiers, lighting systems, sound systems, and the like.

According to an embodiment, the wearable device 101 continuously monitors and receives the biometric parameters of the user 103. In an exemplary implementation, the wearable device 101 collects the biometric parameters (i.e. biomarkers) to access the user's physiological state. The one or more physiological states may include temperature, IMU data, PPG sensors for heart beat and heart beat variability along with the other data as explained above. According to an embodiment, the wearable device 101 further detects whether the biometric parameters are beyond some threshold value and accordingly determines a deviation.

For example, consider that the threshold for the normal body temperature is 36.5° C.-37.5° C. Thus, if the wearable device 101 detects the user's body temperature at 38.2° C. (fever-like condition). Thus, a deviation is detected and an indication of the deviation is provided to the controller unit 109. In a further example, consider that resting heart rate range is 60-100 BPM. Further, the wearable device 101 detects that the resting heart rate of the user is 110 BPM, indicating stress or overheating. Thus, a deviation is detected and an indication of the deviation is provided to the controller unit 109.

In an embodiment, upon detecting the deviation, the controller unit 109 of the environmental sensor module 107 receives the at least one biometric parameters associated with the user 103 from the smart device 111 and the indication of deviation based on the threshold. Further, the controller unit 109 determines the at least one ambient condition of the zone of user's presence. For example, what is the current temperature, current oxygen level, air quality, lightning condition, a current humidity level of the indoor surrounding environment of the user 103. According to some embodiment, the controller unit 109 may also determine the external weather data in addition to the biometric parameters of the user and indoor environmental data.

According to a further embodiment, the controller unit 109 applies an adaptive algorithm that dynamically adjusts HVAC settings by correlating the biometric parameters of the user with real-time environmental conditions. For example, if the user's 103 body temperature is detected as 39° C. and the current room temperature is found to be 20° C. Then the controller unit 109 determines that user may have a fever. Thus, in such a scenario, the controller unit 109 sends a control signal to dynamically change the temperature from 20° C. to 28° C. to comfort the user.

According to some embodiment, the wearable device 101 detects the user's presence in a specific zone, and the controller unit 109 adjusts the HVAC system 105 settings of that zone based on both the biometric parameters and environmental data. For example, the consider that initially, the space is vacant and user come in from outside. In such a scenario, the wearable device 101 detects the user's presence in a specific zone. Further, based on the biometric parameters and external environmental conditions, the controller unit may determine that user is feeling hot as the temperature outside is 40° C. and the temperature inside is 28° C. Then in such a scenario, the controller unit 109 correlate the biometric parameter, indoor ambient temperature, and the external environmental temperature, and adjusts the HVAC system 105 to provide the temperature around 23° C. in order to comfort the user.

According to some embodiment, the software APP may provides real-time feedback and suggestions for HVAC settings, which can be implemented through smart Hub 113. In an embodiment, the regulation of ambient conditions can be performed manually based on the recommendations of the smartphone's software APP.

In an alternative embodiment, the biomarker data i.e. biometric parameter sensed by the wearable device is forwarded to the software APP and subsequently, the data is forwarded to the environmental sensor module 107. The environmental sensor module 107 sends a message to the connected smart hub 113 to regulate one or more conditions of the indoor facility, such as temperature, moisture, ambient light etc.

In a non-limiting embodiment, the smart ring 111 may include a rechargeable battery for continuous monitoring. Further, the environmental sensor module 107 is designed to be always plugged in for continuous power.

Provided below are a few example cases which are implemented using the system 100 of FIG. 1.

### Example Case 1: Optimizing Sleep Environment

Step 1: Sleep Detection
Data Generation: The smart ring detects the user's sleep onset based on biomarker data, such as Motion, heart rate and heart rate variability (HRV).
Data Transmission: The sleep detection data is sent from the smart ring to the smartphone app via Bluetooth.
Step 2: Initial HVAC Adjustment
Data Transmission: The smartphone app sends the sleep detection data to the environment sensing device.
Action: The environment sensing device sends a message to the connected smart home hub to lower the room's temperature.
HVAC Adjustment: The smart home hub communicates with the connected HVAC system to set a cooler temperature, optimizing the environment for the initial phase of sleep.
Step 3: Sleep Duration Monitoring
Data Generation: The smart ring continuously monitors the user's sleep duration and physiological state.
Data Transmission: Updates on the user's sleep duration and physiological state are sent from the smart ring to the smartphone app.
Step 4: Gradual Temperature Adjustment
Data Transmission: The smartphone app sends updates on the user's sleep duration and physiological state to the environment sensing device.
Action: Based on the sleep duration data, the environment sensing device sends a message to the smart home hub to gradually increase the room's temperature.
HVAC Adjustment: The smart home hub communicates with the HVAC system to incrementally raise the temperature, optimizing the environment for the later phases of sleep.

### Example Case 2: Fever Detection and Temperature Adjustment

Step 1: Fever Detection
Data Generation: The smart ring detects an elevated skin temperature indicative of a fever.
Data Transmission: The fever detection data is sent from the smart ring to the smartphone app via Bluetooth.
Step 2: HVAC Adjustment for Comfort
Data Transmission: The smartphone app sends the fever detection data to the environment sensing device.
Action: The environment sensing device sends a message to the connected smart home hub to increase the room's temperature.
HVAC Adjustment: The smart home hub communicates with the connected HVAC system to set a warmer temperature, providing a more comfortable environment for the user with a fever.

### Example Case 3: Exercise Detection and HVAC Adjustment

Step 1: Exercise Detection
Data Generation: The smart ring detects increased movement and elevated heart rate, indicating that the user is exercising.
Data Transmission: The exercise detection data is sent from the smart ring to the smartphone app via Bluetooth.
Step 2: Initial HVAC Adjustment for Cooling
Data Transmission: The smartphone app sends the exercise detection data to the environment sensing device.
Action: The environment sensing device sends a message to the connected smart home hub to lower the room's temperature.
HVAC Adjustment: The smart home hub communicates with the connected HVAC system to set a cooler temperature, providing a comfortable environment for the user during exercise.
Step 4: Adjusting Temperature for Energy Efficiency
Data Transmission: The smartphone app sends updates indicating that the user's body is returning to its normal state to the environment sensing device.
Action: The environment sensing device sends a message to the smart home hub to adjust the room's temperature to a slightly warmer setting, reducing the cooling intensity to save electricity.
HVAC Adjustment: The smart home hub communicates with the HVAC system to implement the new temperature setting, optimizing energy efficiency while still maintaining comfort.

### Example Case 4: Detecting User Absence and Reducing HVAC Operations

Step 1: User Absence Detection
Data Generation: The environment sensing device detects no sound via its microphone and does not detect a connection to the user's smartphone or smart ring via Bluetooth, indicating that the user is not in the room.
Data Analysis: The environment sensing device processes this data to determine that the room is unoccupied.
Step 2: HVAC Adjustment for Energy Saving
Action: The environment sensing device sends a message to the connected smart home hub to reduce HVAC operations.
HVAC Adjustment: The smart home hub communicates with the connected HVAC system to lower the intensity of heating or cooling, or to switch to an energy-saving mode, thereby conserving energy in the absence of the user.
Step 3: Continuous Monitoring for User Return
Continuous Monitoring: The environment sensing device continues to monitor for sound and Bluetooth connections to detect the user's return to the room.
Reactivation: If the user returns to the room, as indicated by sound detection or Bluetooth connection, the environment sensing device sends a message to the smart home hub to resume normal HVAC operations to ensure the user's comfort.

### Example Case 5: Adjusting HVAC Mode Based on Environmental Properties

Step 1: Environmental Data Collection
Data Generation: The environment sensing device continuously monitors the indoor environment, collecting data on humidity levels.
Data Analysis: The device analyses the humidity data to determine if the levels are higher than the optimal range for comfort.
Step 2: HVAC Mode Adjustment
Action: If the humidity is found to be high, the environment sensing device sends a message to the connected smart home hub to set the HVAC system to dehumidification mode.
HVAC Adjustment: The smart home hub communicates with the connected HVAC system to activate the dehumidification mode, which reduces the humidity levels in the room to maintain a comfortable environment.
Step 3: Continuous Monitoring and Adjustment
Continuous Monitoring: The environment sensing device continues to monitor the humidity levels in the room.
Adjustments: If the humidity levels return to the optimal range, the environment sensing device sends a message to the smart home hub to switch the HVAC system back to its regular mode, ensuring the environment remains comfortable while optimizing energy efficiency.

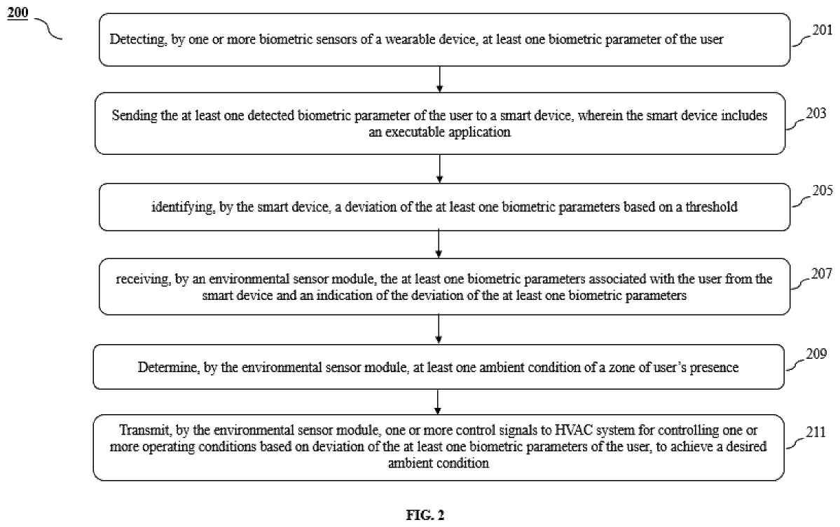

FIG. 2 illustrates a method 200 flow for controlling an HVAC system based on user's biometric parameters, according to an embodiment of the present disclosure. According to an embodiment, the method 200 is implemented in the system 100. The explanation of the same has been explained above, there for the sake of brevity a detailed description has been omitted here.

In an embodiment, the system 100, at step 201 includes detecting, by one or more biometric sensors of a wearable device, at least one biometric parameter of the user. Further, at step 203, the system 100 includes sending the at least one detected biometric parameter of the user to a smart device, wherein the smart device includes an executable application. Further, at step 205, the system 100 includes identifying, by the smart device 111, a deviation of the at least one biometric parameters based on a threshold. Further, at step 207, the system 100 includes receiving, by an environmental sensor module, the at least one biometric parameters associated with the user from the smart device and an indication of the deviation of the at least one biometric parameters. Further, at step 209, the system 100 includes determining, by the environmental sensor module 105, at least one ambient condition of a zone of user's presence. Further, at step 211, the system 100 includes transmit, by the environmental sensor module, one or more control signals to HVAC system for controlling one or more operating conditions based on deviation of the at least one biometric parameters of the user, to achieve a desired ambient condition.

In a further embodiment, the system 100 include controlling, by the environmental sensor module, one or more operating conditions of the HVAC system 105 via a smart home hub 113.

In an embodiment, one or more ambient conditions around the user includes at least one of temperature, humidity, air quality, light levels, noise level, or occupancy level.

In an embodiment, the system 100 includes detecting, by the environmental sensor the ambient conditions, including at least one of temperature, humidity, air quality, light levels, noise level, pressure level, or occupancy level.

In an embodiment, the biometric sensor comprises at least one of a heart rate sensor, a skin temperature sensor, a blood oxygen sensor, a respiratory rate sensor, motion sensor.

In an embodiment, the system 100 includes applying an adaptive algorithm, by the environmental sensor module, to dynamically adjusts HVAC settings by correlating biometric responses of the user with real-time environmental conditions.

In an embodiment, the system 100 includes detecting the user's presence in a specific zone. Further, the system 100 includes adjusting the HVAC settings of that zone based on both the biometric parameters and environmental data.

In an embodiment, the system 100 includes continuously receiving, by the environmental sensor module, at least one biometric parameters associated with the user from the smart device.

In an embodiment, the system 100 includes utilizing external weather data in addition to biometric parameters of the user and indoor environmental data for adjusting HVAC settings for optimal efficiency.

In an embodiment, the system 100 includes continuously monitoring the ambience conditions of the zone of user's presence.

Thus, the disclosed system provides an integrated system designed for the dynamic optimization of HVAC efficiency and lifestyle improvement based on real-time biomarker and environmental data. By incorporating a smart ring with biomarker sensors and an always-plugged-in environment sensing device, the system provides intelligent suggestions for HVAC settings and identifies potential causes of discomfort, enhancing comfort, health, and overall well-being.

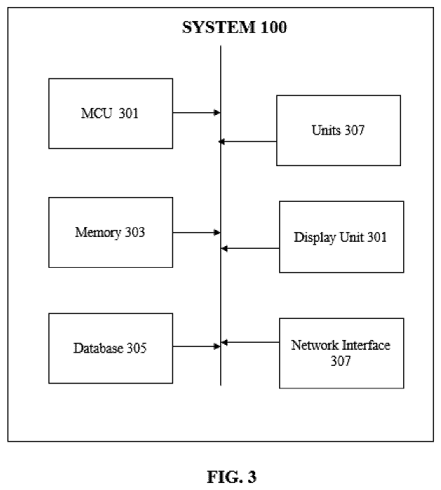

FIG. 3 illustrates a general block diagram of the system 100, according to an embodiment of the present disclosure.

In an example, the MCU 301 may be a single processing unit or a number of units, all of which could include multiple computing units. The MCU 301 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, MCU 301 is configured to fetch and execute computer-readable instructions and data stored in a memory 303.

The memory 303 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the unit(s) 307 may include a program, a subroutine, a portion of a program, a software component or a hardware component capable of performing a stated task or function. As used herein, the unit(s) 307 may be implemented on a hardware component such as a server independently of other modules, or a module can exist with other modules on the same server, or within the same program. The unit(s) 307 may be implemented on a hardware component such as processor one or more microprocessors, microcomputers, microcontrollers, digital signal processors, central processing units, state machines, logic circuitries, and/or any devices that manipulate signals based on operational instructions. The unit(s) 307 when executed by the MCU 301 may be configured to perform any of the described functionalities.

As a further example, the database 305 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the MCU 301.

As an example, the display unit 301 includes a computer monitor, a touch screen, an output device capable of displaying the graphics, and the like. The display unit 301 is configured to display visual output in desktops, laptops, and workstations. The display unit 301 may come in different sizes, resolutions, and types (such as LCD, LED, or OLED).

As a further example, the network interface 307 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

1. A system for controlling an HVAC system based on user's biometric parameters, comprising:
a wearable device worn by a user, wherein the wearable device including at least one biometric sensor configured to measure the biometric parameters of the user;
an environmental sensor module configured to detect ambient conditions in a zone of user's presence and send controlling signal to a HVAC system; and
a smart device coupled to the wearable device and the environmental sensor module, the smart device comprises an executable application configured to receive the at least one biometric parameters of the user and identify a deviation based on a threshold,
wherein the environmental sensor module further comprises a controller unit, said controller unit is configured to:
receive at least one biometric parameters associated with the user from the smart device and an indication of deviation based on the threshold;
determine at least one ambient condition of the zone of user's presence; and
transmit one or more control signals for controlling one or more operating conditions of the HVAC system, based on deviation of the at least one biometric parameters associated with the user, to achieve a desired ambient condition for the user.

2. The system of claim 1, wherein the environmental sensor module is configured to:
control one or more operating conditions of the HVAC system via a smart home hub; and
detect ambient conditions, including at least one of temperature, humidity, air quality, light levels, noise level, pressure level, or occupancy level.

3. The system of claim 1, wherein one or more ambient conditions around the user includes at least one of temperature, humidity, air quality, light levels, noise level, or occupancy level.

4. (canceled)

5. The system of claim 1, wherein the biometric sensor comprises at least one of a heart rate sensor, a skin temperature sensor, a blood oxygen sensor, a respiratory rate sensor, motion sensor.

6. The system of claim 1, wherein the controller unit applies an adaptive algorithm that dynamically adjusts HVAC settings by correlating the biometric parameters of the user with real-time environmental conditions.

7. The system of claim 1, wherein the wearable device detects the user's presence in a specific zone, and the controller unit adjusts the HVAC settings of that zone based on both the biometric parameters and environmental data.

8. The system of claim 1, wherein the controller unit is configured to:
continuously receive at least one biometric parameters associated with the user from the smart device; and
continuously monitor the ambience condition of the zone of user's presence; and
utilize external weather data in addition to the at least one biometric parameters of the user and indoor environmental data to adjust HVAC settings for optimal efficiency.

9. (canceled)

10. (canceled)

11. The system of claim 1, wherein the smart device coupled to the wearable device and environmental sensor module comprises at least one of a smart-phone or a tablet, and
wherein the wearable device is a smart ring.

12. (canceled)

13. A method for controlling an HVAC system based on user's biometric parameter, comprising:
detecting, by one or more biometric sensors of a wearable device, at least one biometric parameter of the user;
sending the at least one detected biometric parameter of the user to a smart device, wherein the smart device includes an executable application;
identifying, by the smart device, a deviation of the at least one biometric parameters based on a threshold;
receiving, by an environmental sensor module, the at least one biometric parameters associated with the user from the smart device and an indication of the deviation of the at least one biometric parameters;
determine, by the environmental sensor module, at least one ambient condition of a zone of user's presence; and
transmit, by the environmental sensor module, one or more control signals to HVAC system for controlling one or more operating conditions based on deviation of the at least one biometric parameters of the user, to achieve a desired ambient condition.

14. The method of claim 13, further comprising:
controlling, by the environmental sensor module, one or more operating conditions of the HVAC system via a smart home hub.

15. The method of claim 13, wherein one or more ambient conditions around the user includes at least one of temperature, humidity, air quality, light levels, noise level, or occupancy level.

16. The method of claim 13, wherein further comprising: detecting ambient conditions, including at least one of temperature, humidity, air quality, light levels, noise level, pressure level, or occupancy level.

17. The method of claim 13, wherein the biometric sensor comprises at least one of a heart rate sensor, a skin temperature sensor, a blood oxygen sensor, a respiratory rate sensor, motion sensor.

18. The method of claim 13, comprising:
applying an adaptive algorithm, by the environmental sensor module, to dynamically adjusts HVAC settings by correlating biometric responses of the user with real-time environmental conditions;
detecting the user's presence in a specific zone; and
adjusting the HVAC settings of that zone based on both the biometric parameters and environmental data.

19. (canceled)

20. The method of claim 9, further comprising:
continuously receiving, by the environmental sensor module, at least one biometric parameters associated with the user from the smart device;
continuously monitoring the ambience conditions of the zone of user's presence; and
utilizing external weather data in addition to the at least one biometric parameters of the user and indoor environmental data for adjusting HVAC settings for optimal efficiency.

21. (canceled)

22. (canceled)
